(19) United States
(12) Patent Application Publication
(10) Pub. No.: US 2024/0210594 A1
(43) Pub. Date: Jun. 27, 2024

(54) OPTICAL MEMBER

(71) Applicant: FUJIFILM Corporation, Tokyo (JP)

(72) Inventors: Hideki YASUDA, Kanagawa (JP); Yujiro YANAI, Kanagawa (JP); Yukito SAITOH, Kanagawa (JP)

(73) Assignee: FUJIFILM Corporation, Tokyo (JP)

(21) Appl. No.: 18/441,604

(22) Filed: Feb. 14, 2024

Related U.S. Application Data
(63) Continuation of application No. PCT/JP2022/032573, filed on Aug. 30, 2022.

(30) Foreign Application Priority Data
Aug. 31, 2021 (JP) 2021-140895
Jun. 14, 2022 (JP) 2022-095602

(51) Int. Cl. G02B 1/00; G02B 5/30

(52) U.S. Cl. CPC G02B 1/002; G02B 5/3016

(57) ABSTRACT

An optical member using a metasurface structure and having high use efficiency of light. The optical member includes a substrate, a metasurface structure configured of a plurality of arrayed microstructures formed on at least one surface of the substrate, having a plurality of regions A each including, in a case where a region including one or more of the microstructures is defined as a region X, a plurality of the regions X in which phase modulation amounts are different from each other, and a phase correction layer that corrects a wavefront aberration of the metasurface structure, wherein the phase modulation amounts in the regions X of the metasurface structure gradually decrease in one direction, and the phase correction layer includes, corresponding to the region A, a region whose phase modulation amount changes.

### CROSS-REFERENCE TO RELATED APPLICATIONS

This application is a Continuation of PCT International Application No. PCT/JP2022/032573 filed on Aug. 30, 2022, which claims priority under 35 U.S.C. § 119(a) to Japanese Patent Application No. 2021-140895 filed on Aug. 31, 2021 and Japanese Patent Application No. 2022-095602 filed on Jun. 14, 2022. The above applications are hereby expressly incorporated by reference, in their entirety, into the present application.

### BACKGROUND OF THE INVENTION

### 1. Field of the Invention

The present invention relates to an optical member using a metasurface structure.

### 2. Description of the Related Art

Metasurface structures can bend electromagnetic waves including visible light in a desired direction by imparting desired phase characteristics to transmitted waves and reflected waves according to an array of microstructures. Thus, metasurface structures are expected to be applied to various optical members such as condenser lenses, collimator lenses, and diffraction gratings.

Here, as described above, metasurface structures impart a phase characteristic to electromagnetic waves according to an array of microstructures, thereby refracting the electromagnetic waves, for example.

An optical member using such a metasurface structure is in the form of a flat plate, does not have to be thick like a typical optical refractive lens, and does not have to form unevenness or the like having a steep groove structure like a diffraction lens (Fresnel lens).

That is, a very thin flat plate-shaped optical member can be realized by using the metasurface structure.

Thus, various proposals have been made regarding the metasurface structure.

For example, JP2017-175201A describes a film (metamaterial film) having a metasurface structure in which a plurality of fine resonators that resonate with electromagnetic waves having specific wavelength of 400 to 2000 nm are disposed in a plane direction of a resin film having a thickness of 50 μm or less that transmits electromagnetic waves having wavelengths of 400 to 2000 nm.

This film, with which the metasurface structure can be easily mounted on an object having a curved surface and an uneven surface, enables the metasurface structure to be used for substances having various shapes.

### SUMMARY OF THE INVENTION

As described above, the metasurface structure is usually formed of an array of microstructures.

Specifically, the metasurface structure is formed by arraying, on a plane, resonators, which are microstructures made of a metal or a dielectric, and the metasurface structure includes an array of unit cells formed by the resonators and spaces around the resonators.

That is, the metasurface structure has a two dimensionally discrete structure.

Thus, the metasurface structure has a wavefront aberration, and the wavefront of transmitted or reflected electromagnetic waves has a spatially discrete phase distribution, which deviates from an ideal continuous phase distribution.

For example, as conceptually illustrated in FIG. 21, in a case where a plane wave fw is transmitted through a lens (metalens) 100 using a metasurface structure and is condensed, the phase distribution deviates from the design value, and the wavefront becomes a curved surface having a disturbance, not an ideal curved surface indicated by broken lines.

As a result, in a condenser lens using the metasurface structure, defects occur such as shift of the position of a focal point F, spread of the focal point F, and concentration of light at a position other than the focal point F.

In a collimating lens using the metasurface structure, defects such as a decrease in parallelism of transmitted beam occur. In a diffraction grating using the metasurface structure, defects such as a decrease in diffraction efficiency occur.

That is, an optical member using a conventional metasurface structure has a problem that the use efficiency of light is not sufficient.

An object of the present invention is to solve such a problem of the conventional technology and to provide an optical member using a metasurface structure and having high use efficiency of light.

In order to accomplish the object, the present invention has the following configuration.
[1] An optical member comprising:
a substrate;
a metasurface structure configured of a plurality of arrayed microstructures formed on at least one surface of the substrate, having a plurality of regions A each including, in case where a region including one or more of the microstructures is defined as a region X, a plurality of the regions X in which phase modulation amounts are different from each other; and
a phase correction layer that is formed on at least one surface of the substrate and corrects a wavefront aberration of the metasurface structure,
in which in the metasurface structure, the phase modulation amounts of the regions X forming the region A gradually decrease in one direction, and the phase correction layer has a region in which the phase modulation amount changes, corresponding to the region A.
[2] The optical member according to [1],
in which the phase correction layer has a region in which the phase modulation amount gradually decreases, corresponding to the region A.
[3] The optical member according to [1] or [2],
in which the phase correction layer has a region in which the phase modulation amount changes, corresponding to two or less of the regions X.
[4] The optical member according to [3],
in which the phase correction layer has a region in which the phase modulation amount changes, corresponding to each of the regions X.
[5] The optical member according to any one of [1] to [4],
in which the phase correction layer is a layer formed using a liquid crystal compound.
[6] The optical member according to [5],
in which the phase correction layer has a plurality of regions containing the liquid crystal compound having different alignment directions.
[7] The optical member according to [6],
in which the alignment directions of the liquid crystal compounds continuously change in the region containing the liquid crystal compound having different alignment directions.
[8] The optical member according to any one of [1] to [4],
in which the phase correction layer is formed of a member of which a height changes in accordance with the phase modulation amount.
[9] The optical member according to [8],
in which in the member of which a height changes in accordance with the phase modulation amount, the height of the member continuously changes.
[10] The optical member according to any one of [1] to [9],
in which the optical member is any of a transmissive lens, a transmissive diffraction grating, a reflective lens, or a reflective diffraction grating.
[11] The optical member according to any one of [1] to [10],
in which a wavelength of light to be targeted by the metasurface structure is 10 μm to 1 cm.

The present invention provides an optical member using a metasurface structure and having high use efficiency of light (electromagnetic waves including visible light).

### BRIEF DESCRIPTION OF THE DRAWINGS

FIG. 1 is a diagram conceptually illustrating an example of an optical member according to an embodiment of the present invention.

FIG. 2 is a conceptual diagram for describing an example of a configuration of the optical member according to the embodiment of the present invention.

FIG. 3 is a diagram conceptually illustrating an example of phase characteristics of a metasurface structure.

FIG. 4 is a diagram conceptually illustrating an example of a metasurface structure.

FIG. 5 is a conceptual diagram for describing an outline of the optical member according to the embodiment of the present invention.

FIG. 6 is a conceptual diagram for describing an example of the optical member according to the embodiment of the present invention.

FIG. 7 is a conceptual diagram for describing another example of the optical member according to the embodiment of the present invention.

FIG. 8 is a diagram conceptually illustrating another example of the optical member according to the embodiment of the present invention.

FIG. 9 is a diagram conceptually illustrating another example of the optical member according to the embodiment of the present invention.

FIG. 10 is a diagram conceptually illustrating another example of the optical member according to the embodiment of the present invention.

FIG. 11 is a diagram conceptually illustrating another example of the optical member according to the embodiment of the present invention.

FIG. 12 is a diagram conceptually illustrating another example of the optical member according to the embodiment of the present invention.

FIG. 13 is a conceptual diagram for describing a unit cell of an Example.

FIG. 14 is a conceptual diagram for describing an Example of the present invention.

FIG. 15 is a conceptual diagram for describing an Example of the present invention.

FIG. 16 is a conceptual diagram for describing an Example of the present invention.

FIG. 17 is a conceptual diagram for describing an Example of the present invention.

FIG. 18 is a conceptual diagram for describing an Example of the present invention.

FIG. 19 is a conceptual diagram for describing an Example of the present invention.

FIG. 20 is a conceptual diagram for describing an Example of the present invention.

FIG. 21 is a conceptual diagram for describing a metasurface structure.

### DESCRIPTION OF THE PREFERRED EMBODIMENTS

Hereinafter, an optical member according to an embodiment of the present invention will be described in detail based on preferred Examples shown in the accompanying drawings.

In the present specification, a numerical range expressed using “to” means a range including numerical values described before and after “to” as a lower limit value and an upper limit value.

In the present specification, “the same” includes an error range usually accepted in the technical field.

All of the drawings shown below are conceptual drawings for describing an optical member according to an embodiment of the present invention. Thus, the shape, size, thickness, positional relationship, and the like of each member do not necessarily match the actual ones.

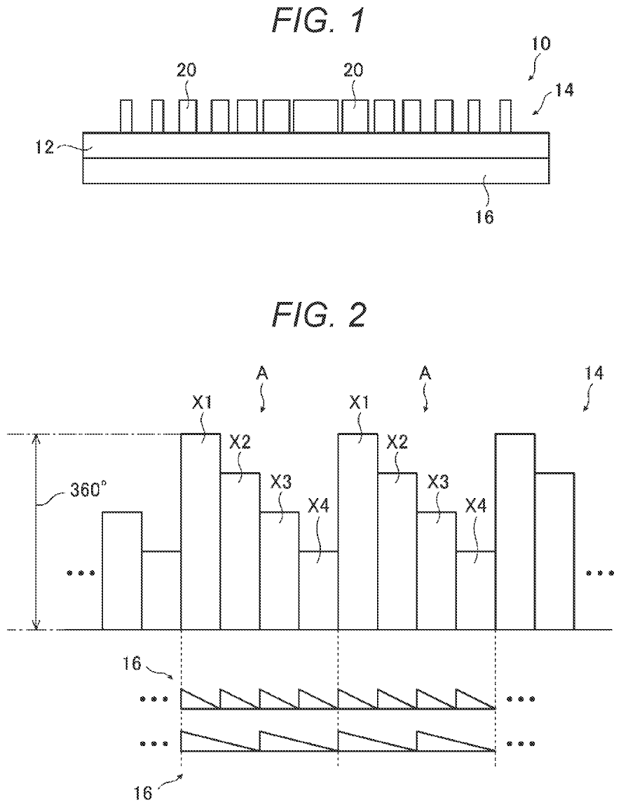

FIG. 1 conceptually illustrates an example of an optical member according to an embodiment of the present invention.

An optical member 10 illustrated in FIG. 1 includes a substrate 12, a metasurface structure 14 formed on one surface of the substrate 12, and a phase correction layer 16 formed on the other surface of the substrate 12.

In the illustrated example, the optical member 10 is, for example, a transmissive type condenser lens (meta-condenser lens) using the metasurface structure 14.

The metasurface structure 14 is formed by arraying resonators 20, which are microstructures, on a surface of the substrate 12. The metasurface structure 14 performs phase modulation using resonance of the resonators 20 according to an array of unit cells including one resonator 20 and a space around the resonator 20, and bends electromagnetic waves including visible light according to the Huygens' principle.

In the following description, for convenience, electromagnetic waves having various wavelengths including visible light are collectively referred to as “light”. As described above, since the optical member 10 is a transmissive type condenser lens, the metasurface structure 14 refracts transmitted light by phase modulation and condenses the light.

The phase correction layer 16 corrects a wavefront aberration of the metasurface structure 14.

That is, the phase correction layer 16 adjusts the phase of light transmitted through the metasurface structure 14 to obtain an appropriate phase distribution and makes the wavefront of the light have an appropriate curved surface (spherical wave).

In a case where the optical member according to the embodiment of the present invention is a reflective type as illustrated in FIG. 12 described later, the phase correction layer 16 adjusts the phase of light transmitted through the metasurface structure 14 and the substrate 12, reflected by a reflective layer 38, and transmitted through the substrate 12 and the metasurface structure 14 again to obtain an appropriate phase distribution, and makes the wavefront of the light have an appropriate curved surface (spherical wave).

In the optical member 10 illustrated in the drawing, the substrate 12 supports the metasurface structure 14 and the phase correction layer 16. In a case where the optical member according to the embodiment of the present invention is a reflective type as illustrated in FIG. 12 described later, the substrate 12 supports the metasurface structure 14 and the reflective layer 38.

The substrate 12 is not limited, and various well-known sheet-shaped materials (films or plate-shaped materials) can be used as long as the substrate can support the metasurface structure 14 and the phase correction layer 16 and can allow transmission of light having a target wavelength of the optical member 10 (metasurface structure 14).

Examples of the substrate 12 include a metal substrate having an oxide insulating layer such as a silicon substrate having silicon oxide, a substrate made of an oxide such as silicon oxide, a semiconductor substrate such as a germanium substrate and a chalcogenide glass substrate, a polyacrylic resin film such as polymethyl methacrylate, a cellulose resin film such as cellulose triacetate, a cycloolefin polymer film, a resin film such as a polyethylene terephthalate (PET) film, a polycarbonate film, and a polyvinyl chloride film, and a glass plate. Examples of the cycloolefin polymer film include “ARTON” (trade name, manufactured by JSR Corporation) and “ZEONOR” (trade name, manufactured by Zeon Corporation).

The thickness of the substrate 12 is not limited either, and the thickness may be appropriately set according to the forming material of the substrate 12 in such a manner that the metasurface structure 14 and the phase correction layer 16 can be supported, sufficient transmittance can be obtained with respect to target light of the optical member 10, and sufficient strength can be obtained according to the use of the optical member 10.

The metasurface structure 14 is formed on one surface of the substrate 12.

As described above, the metasurface structure 14 is formed by two dimensionally arraying the resonators 20, which are microstructures, apart from each other on a place. The metasurface structure 14 is basically formed by an array of unit cells each formed by one resonator 20 and a space around the resonator 20.

In the optical member according to the embodiment of the present invention, the metasurface structure is basically a known metasurface structure (metamaterial).

Thus, the shape and forming material of the resonators 20, the array of the resonators 20, the interval (pitch) of the resonators 20, and the like are not limited.

The metasurface structure 14 may be designed by a known method according to intended optical characteristics. As an example, the amplitude and phase of the wave transmitted through the resonator 20 to be used may be calculated using commercially available simulation software, and the array of the resonators 20 may be set so as to obtain a target distribution of the phase modulation amount (refractive index).

The optical member 10 of the illustrated example, that is, the metasurface structure 14, is a transmission type condenser lens (transmissive lens) as an example.

Thus, the metasurface structure 14 modulates the phase of transmitted light by using resonance of the resonators 20 according to the array of the unit cells, and refracts and condenses the light according to the Huygens' principle by the phase modulation.

The optical member according to the embodiment of the present invention, that is, the metasurface structure constituting the optical member according to the embodiment of the present invention is not limited to the transmission type condenser lens as in the illustrated example. That is, the optical member according to the embodiment of the present invention, that is, the metasurface structure constituting the optical member according to the embodiment of the present invention may be a transmissive diffraction grating, a reflective lens, a reflective diffraction grating (reflect array), or the like.

FIG. 2 conceptually illustrates phase modulation characteristics of the optical member 10.

As conceptually illustrated in the upper part of FIG. 2, the metasurface structure 14 has a configuration in which regions A including a plurality of regions X having different phase modulation amounts of light to be transmitted are arrayed in a plane direction of the substrate 12. The region X has one resonator 20. Thus, the region X corresponds to one unit cell in the metasurface structure 14.

In the optical member according to the embodiment of the present invention, the number of resonators 20 in one region X, that is, the number of resonators 20 in one unit cell is basically one, but the present invention is not limited to this number. That is, in the optical member according to the embodiment of the present invention, one region X may have a plurality of resonators 20 depending on intended optical characteristics, the size, forming material, and shape of the resonator 20, the size of the region X, and the like as necessary. However, in a case where one region X has a plurality of resonators 20, the phase modulation amounts in the spaces where the resonators of the region X are present are basically equal to each other.

In FIG. 2, the height of the region X indicates the phase modulation amount of transmitted light. The phase modulation amount of transmitted light in FIG. 2 is a delay amount of the phase of transmitted light. The maximum value of the phase modulation amount of transmitted light in the region X is 360°.

In FIG. 2, a lateral direction is a plane direction of the substrate 12.

In the illustrated example, the region A includes, for example, four regions X1 to X4 having phase modulation amounts different from each other. In one region A, the regions X (unit cells) are arrayed in the order of the region X1, the region X2, the region X3, and the region X4 in such a manner that the modulation amount sequentially decreases in one direction.

As described above, the optical member 10, that is, the metasurface structure 14 illustrated in FIG. 1 is a condenser lens.

Thus, as an example, in the region A, the regions X (unit cells) are arrayed in such a manner that the phase modulation amount gradually decreases from the center toward an outer direction. Further, the size of the region A in the plane direction gradually decreases from the center toward the outer direction. Thus, on a straight line passing through the center of the condenser lens, the direction in which the region X gradually decreases in size in the region A and the direction in which the region A gradually decreases in size are reversed on both sides of the center.

In a case where the optical member is, for example, a concave lens, the regions X are arrayed in such a manner that the phase modulation amount gradually increases in size from the center toward the outer direction in the region A.

Further, in a case where the optical member is, for example, a diffraction grating, the regions A having the same size are arrayed in one direction according to the light diffraction direction in such a manner that the direction coincides with the direction in which the regions X gradually decrease in size.

By appropriately selecting and combining the shape and the forming material of the resonator 20, the array of the resonators 20, the interval between the resonators 20, and the like, the optical characteristics of the metasurface structure 14 serving as a condenser lens, such as a focal length, can be appropriately set.

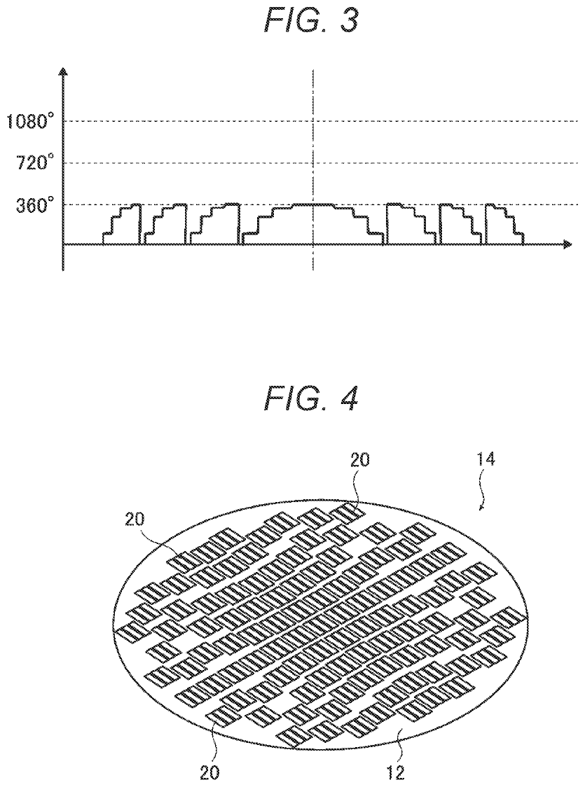

FIG. 3 conceptually illustrates an example of the phase modulation characteristics of the metasurface structure 14.

As in FIG. 2, the height (vertical axis) indicates the phase modulation amount (delay amount) of transmitted light, and the horizontal axis indicates the plane direction of the substrate 12 in FIG. 3. The phase modulation amount is 360° at maximum. The one dot chain line indicates the optical axis of the optical member 10 (metasurface structure 14), that is, the optical axis of the condenser lens.

As described above, the metasurface structure 14 has the region A in which four regions X are arrayed in such a manner that the phase modulation amount (phase delay amount) gradually decreases from the center toward the periphery. The region A gradually decreases in size in the plane direction from the center toward the periphery in such a manner that the phase modulation amount gradually decreases from the center toward the periphery. Since the metasurface structure 14 has such phase modulation characteristics, the metasurface structure 14 condenses incident and transmitted light according to the Huygens' principle.

FIG. 4 conceptually illustrates an example of the configuration of the metasurface structure 14 acting as a condenser lens.

In the metasurface structure 14, the resonators 20 having a rectangular parallelepiped shape are arrayed on the surface of the substrate 12. In the illustrated example, the resonators 20 are arrayed in such a manner that the directions of the longest sides of the rectangular parallelepipeds coincide with each other.

The metasurface structure 14 illustrated in FIG. 4 mainly corresponds to linearly polarized light in a direction of the longest side of the rectangular parallelepiped of the resonator 20.

By disposing such resonators 20 at adjusted intervals to array unit cells (regions A), light is refracted and condensed according to the Huygens' principle by phase modulation.

As described above, in the optical member 10 according to the embodiment of the present invention, the forming material of the resonator 20 constituting the metasurface structure 14 is not limited, and various materials used as a resonator in a known metasurface structure can be used.

Examples of the material forming the resonator 20 of the metasurface structure 14 include a metal and a dielectric. In the case of a metal, copper, gold, and silver are preferably exemplified from the viewpoint of small optical loss and the like. In the case of a dielectric, silicon, titanium oxide, and germanium are preferably exemplified from the viewpoint that the refractive index is large and large phase modulation can be made.

The shape of the resonator 20 forming the metasurface structure 14 is not limited either, and various shapes used as a resonator in a known metasurface structure can be used.

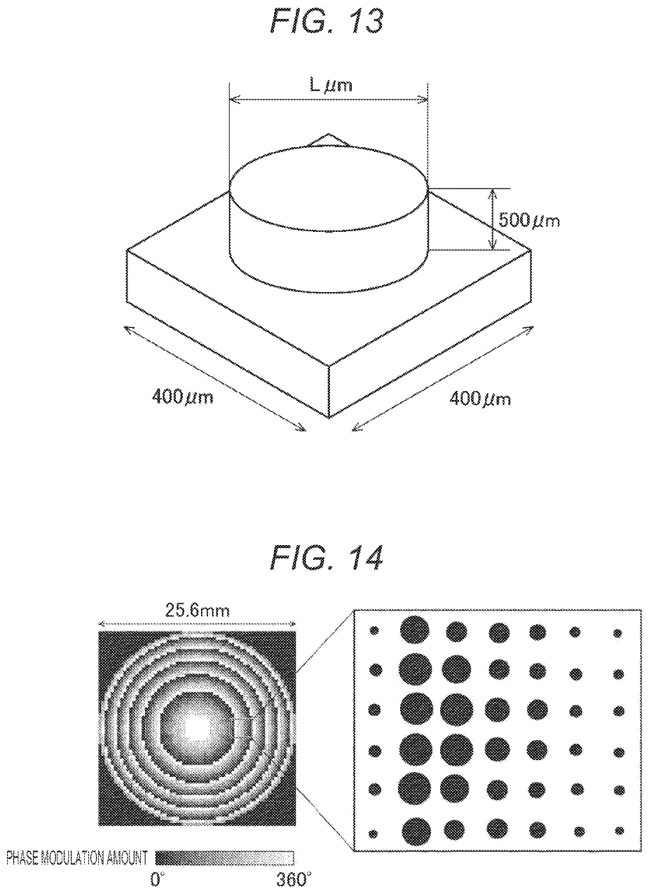

Examples of the shape include a rectangular parallelepiped shape as described above, a cylindrical shape as illustrated in Example 1 (see FIG. 13) described later, a square plate shape as illustrated in Example 3 described later, a solid having a V-shaped bottom surface such that rectangular parallelepipeds are connected at end portions as illustrated in JP2018-46395A, a solid having a cross-shaped bottom surface such that rectangular parallelepipeds are intersected, a solid having a substantially H-shaped bottom surface such as H-steel, and a solid having a substantially C-shaped bottom surface such as C-channel.

In addition, as illustrated in JP2018-46395A, various shapes in which an angle formed by two rectangular parallelepipeds is adjusted can be used for a solid having a V-shaped bottom surface and a solid having a cross-shaped bottom surface.

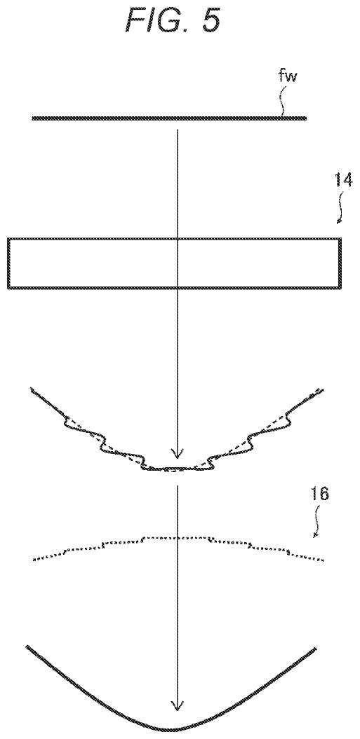

In addition to this, a solid or the like having a bottom surface shape as illustrated in FIG. 5 of “Appl. Sci. 2018, 8 (9), 1689; https://doi.org/10.3390/app8091689” can also be used.

In the metasurface structure 14, only one resonator 20 having such a shape may be used, or a plurality of resonators 20 having such shapes may be used in combination.

The orientations of the same resonators 20 may be the same as illustrated in FIG. 4, may be different from each other, or may be mixed orientations in which the same orientations and different orientations are mixed.

In the optical member 10 according to the embodiment of the present invention, the target wavelength of light of the metasurface structure 14 is not limited, and electromagnetic waves having various wavelengths including visible light can be targeted.

Among these, light having a wavelength of 10 μm to 1 cm is suitably exemplified from the viewpoint that use efficiency of light is low in an optical member such as a lens and a diffraction grating produced by a conventional technology.

The optical member according to the embodiment of the present invention is not limited to a transmission type condenser lens as described above, and various known optical members that can be realized by a metasurface structure such as a collimator lens, a concave lens (diffusing lens), and a diffraction grating can be used. Further, as will be described later, a reflective lens, a reflective diffraction grating, and the like may be formed by combining with a reflective plate.

The action of the optical member according to the embodiment of the present invention, that is, the metasurface structure, can be set by appropriately selecting and combining the shape and the forming material of the resonator 20, the array of the resonators 20, the interval between the resonators 20, and the like. The characteristics of the optical member such as the diffraction angle of light with the diffraction grating can also be adjusted by appropriately combining these elements like the condenser lens.

In the optical member 10, the phase correction layer 16 is provided on the surface of the substrate 12 opposite to the metasurface structure 14.

As described above, the phase correction layer 16 is a layer that corrects the wavefront aberration of the metasurface structure 14. That is, the phase correction layer 16 adjusts the phase of light transmitted through the metasurface structure 14 to obtain an appropriate phase distribution and makes the wavefront have an appropriate curved surface (spherical wave).

Such a phase correction layer 16 has regions having different phase modulation amounts corresponding to the regions A of the metasurface structure 14.

As described above, the metasurface structure 14 is configured by arraying unit cells configured by the resonator 20 and a space around the resonator 20 by arraying the resonator 20 which is a microstructure. Thus, the metasurface structure 14 has a two dimensionally discrete structure.

Such a metasurface structure 14 has a wavefront aberration.

Thus, as conceptually illustrated in FIG. 21 described above and FIG. 5, in a case where the plane wave fw is incident on and transmitted through the metasurface structure 14, the wavefront of light condensed by phase modulation according to the Huygens' principle does not become an ideal curved surface (spherical wave) indicated by a broken line, but becomes a curved surface in which the phase distribution is different from the design value and disturbed.

On the other hand, the optical member 10 according to the embodiment of the present invention includes the phase correction layer 16 in addition to the metasurface structure 14.

As described above, the phase correction layer 16 has regions having different phase modulation amounts corresponding to the regions A of the metasurface structure 14. Specifically, the phase correction layer 16 has regions having different phase modulation amounts corresponding to the regions A of the metasurface structure 14, and adjusts the phase of light transmitted through the metasurface structure 14 in a direction opposite to the shift of the phase of the light transmitted through the metasurface structure 14.

As a result, the phase correction layer 16 corrects the wavefront aberration of the metasurface structure 14, and as conceptually illustrated in FIG. 5, the light condensed by the metasurface structure 14 is set as light in which the wavefront is an appropriately curved surface as an appropriate phase distribution.

FIG. 2 conceptually illustrates an example of characteristics of phase modulation by the phase correction layer 16.

In FIG. 2, the height of the phase correction layer 16 indicates the phase modulation amount with the phase correction layer 16. This phase modulation amount is a delay amount of the phase given to transmitted light by the phase correction layer 16. The lateral direction is a plane direction of the substrate 12 as in the metasurface structure 14.

As illustrated in FIG. 2, the phase correction layer 16 has a region in which the phase modulation amount decreases corresponding to the phase modulation amount in the region A of the metasurface structure 14. Specifically, the phase correction layer 16 has a region in which the phase modulation amount decreases according to the array of the region X in the region A of the metasurface structure 14, that is, a decrease in the phase modulation amount in one direction.

As a result, the phase correction layer 16 can adjust the phase of light transmitted through and condensed by the metasurface structure 14 in a direction opposite to the direction of the shift because of the wavefront aberration to obtain light having a wavefront with an appropriate curved surface as an appropriate phase distribution.

In the example illustrated in FIG. 2, as a preferable aspect, the phase correction layer 16 illustrated in the lower part has one region in which the phase modulation amount gradually decreases corresponding to two regions X. In the example illustrated in FIG. 2, as a more preferable aspect, the phase correction layer 16 illustrated in the upper part has one region in which the phase modulation amount gradually decreases corresponding to each region X.

However, in the optical member 10 according to the embodiment of the present invention, the phase correction layer 16 is not limited to these configurations. For example, the phase correction layer may have one region in which the phase modulation amount gradually decreases, corresponding to the region A.

Here, the reason of the metasurface structure 14 having a wavefront aberration is that, as described above, the metasurface structure 14 has a discrete configuration in which unit cells constituted by the resonators 20 and the surrounding space are arrayed.

That is, the reason of the metasurface structure 14 having a wavefront aberration is that the metasurface structure 14 is formed of an array of unit cells, that is, regions X in which the phase modulation amount is constant.

In consideration of this point, in the phase correction layer 16, the region where the phase modulation amount gradually decreases preferably corresponds to two or a smaller number of the regions X as in the phase correction layer 16 illustrated in the lower part of FIG. 2, and more preferably corresponds to each region X as in the phase correction layer 16 illustrated in the upper part of FIG. 2.

As a preferable aspect of the phase correction layer 16 illustrated in FIG. 2, the phase modulation amount gradually decreases in one direction in one region, but the present invention is not limited to this configuration.

For example, depending on the distance between the metasurface structure 14 and the phase correction layer 16, the phase disturbance caused by the metasurface structure 14 may be weakened, and the state of the phase disturbance may be different between immediately after passing through the metasurface structure 14 and in a case of incidence into the phase correction layer 16. That is, in the optical member 10 according to the embodiment of the present invention, the phase disturbance of light in a case where the light is incident into the phase correction layer 16 changes depending on various factors.

Accordingly, the phase correction layer 16 of the optical member 10 according to the embodiment of the present invention may have, in one region, a region in which the phase modulation amount is uniform in one direction, a region in which the phase modulation amount increases in one direction, or both of them.

Further, in the example illustrated in FIG. 2, the phase modulation amount gradually decreases (changes) continuously in the phase correction layer 16, but the present invention is not limited to this configuration.

That is, in the optical member according to the embodiment of the present invention, for example, the phase modulation amount in the phase correction layer 16 may gradually decrease in a stepwise manner corresponding to one region X, or may gradually decrease in a stepwise manner corresponding to a plurality of regions X.

In addition, as described above, a region in which the phase modulation amount is uniform in one direction and a region in which the phase modulation amount increases in one direction may be provided in the middle.

The modulation amount of the phase in the phase correction layer 16 is not limited.

Here, the phase modulation amount with the metasurface structure 14 is 360° at maximum. In consideration of this point, it is preferable that the modulation amount of the phase in the phase correction layer 16 is set to 180° at maximum.

Setting the modulation amount of the phase in the phase correction layer 16 to 180° or less can reduce excessive correction of the disorder of the phase of transmitted light of the metasurface structure 14 and can obtain light having a more appropriate wavefront.

The thickness of the phase correction layer 16 is not limited either, and may be appropriately set according to the forming material of the phase correction layer 16, the desired modulation amount of the phase, and the like. The thickness of the phase correction layer 16 is preferably 1 to 10,000 μm, more preferably 10 to 5000 μm, and still more preferably 100 to 2000 μm.

The phase correction layer 16 is not limited, and various layers that can modulate the phase of transmitted light can be used.

Examples of a preferable phase correction layer 16 include a layer formed using a liquid crystal compound. FIG. 1 illustrates the phase correction layer 16 formed using a liquid crystal compound.

Specifically, examples thereof include the phase correction layer 16 including a liquid crystal alignment pattern layer in which regions having different phase modulation amounts are provided in a plane by adjusting the alignment direction of the liquid crystal compound.

Examples thereof include the phase correction layer 16 in which regions including a liquid crystal compound having different alignment directions are provided and arrayed corresponding to preferably two regions X (unit cells) and more preferably one region X, as described above.

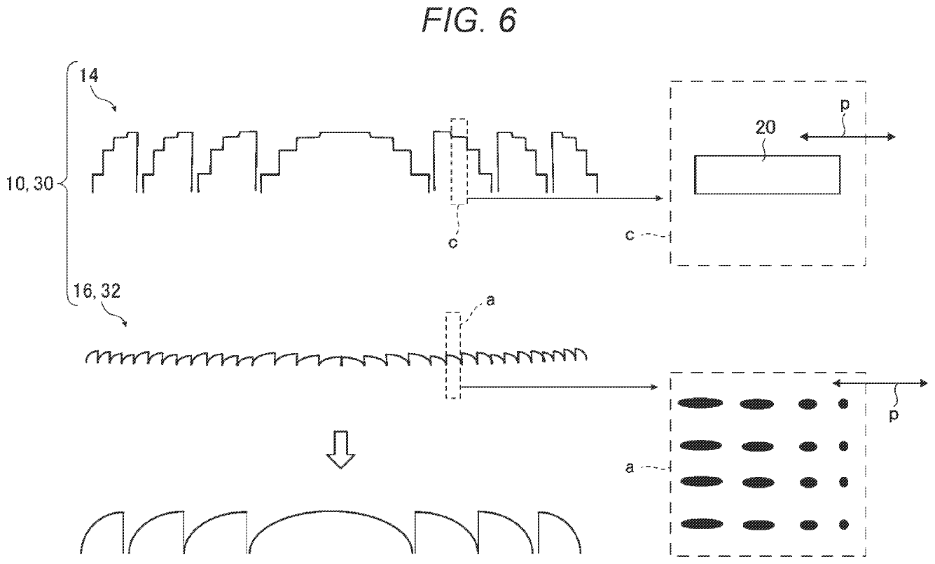

FIG. 6 conceptually illustrates a combination of the metasurface structure 14 and the phase correction layer 16 in a case where the metasurface structure 14 having the phase modulation characteristics illustrated in FIG. 3 and acting as a condenser lens is used.

In the example illustrated in FIG. 6, as a more preferable aspect, the phase correction layer 16 has one region a corresponding to one region X (unit cell) indicated by the broken line c.

In the example illustrated in FIG. 6, the unit cell is formed of the resonator 20 having a rectangular parallelepiped shape as illustrated in FIG. 4, and a polarization direction p of target light is a direction of the longest side of the rectangular parallelepiped of the resonator 20 as described above.

The phase correction layer 16 illustrated in FIG. 6 uses, for example, a rod-like liquid crystal compound, and has a rod-like liquid crystal compound having different alignment directions in the region a.

In a case where the rod-like liquid crystal compound is horizontally aligned, that is, aligned in a plane direction, the phase modulation amount is large, that is, the refractive index is large. The case where the rod-like liquid crystal compound is horizontally aligned is a case indicated by longest circles in the region a.

The closer to the vertical alignment, the smaller the phase modulation amount, that is, the smaller the refractive index, and in the vertical alignment, that is, in the state of being aligned in a thickness direction, the phase modulation amount is minimized, that is, the refractive index is minimized. The case where the rod-like liquid crystal compound is vertically aligned is a case indicated by circles in the region a.

Accordingly, as illustrated in FIG. 6, the region a in which the rod-like liquid crystal compound is aligned in such a manner that the refractive index gradually decreases toward the array of the region X in the region A of the metasurface structure 14, that is, a decrease direction of the phase modulation amount, is arrayed corresponding to the region X of the metasurface structure 14.

With this configuration, due to a combination of the discrete phase modulation distribution of the metasurface structure 14 illustrated in the upper part of FIG. 6 and the phase modulation distribution corresponding to the region X of the metasurface structure 14 because of the phase correction layer 16 illustrated in the middle part of FIG. 6, the phase modulation characteristics of the optical member 10 have a continuous phase modulation distribution illustrated in the lower part of FIG. 6.

As a result, the wavefront aberration of the metasurface structure 14 can be corrected, and the wavefront of light to be condensed can be set to an appropriate curved surface shape.

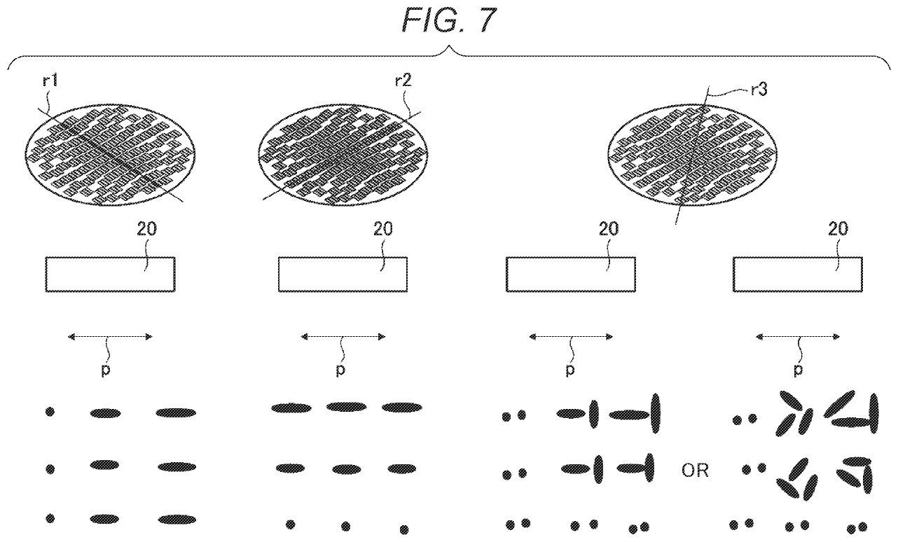

FIG. 7 conceptually illustrates an example of the alignment pattern of the liquid crystal corresponding to the metasurface structure 14 illustrated in FIG. 4 described above.

In the example illustrated in FIG. 7, in the phase correction layer 16, as illustrated on the left side of FIG. 7, a region in which the rod-like liquid crystal compound is aligned is arrayed in a direction rl of the longest side of the rectangular parallelepiped of the resonator 20 in such a manner that the refractive index, that is, the phase modulation amount gradually increases from the center toward the peripheral direction. As described above, the direction of the longest side of the rectangular parallelepiped of the resonator 20 is also the polarization direction of target light.

Thus, as illustrated in the center of FIG. 7, the rod-like liquid crystal compound having the same alignment direction is arrayed in a direction r2 orthogonal to the direction r1.

Further, in a direction r3 at the middle of r1 and r2, as illustrated in the right side of FIG. 7, the rod-like liquid crystal compound is arrayed as a multi-domain in which the alignment direction of the rod-like liquid crystal compound in the plane direction is two types or a random horizontal domain in which the alignment direction of the rod-like liquid crystal compound in the plane direction is various directions.

In the optical member 10 according to the embodiment of the present invention, in the phase correction layer 16 using a liquid crystal compound, that is, the liquid crystal alignment pattern layer, the liquid crystal compound is not limited, and accordingly, the liquid crystal compound may be a rod-like liquid crystal compound as illustrated in FIGS. 6 and 7 or a disk-like liquid crystal compound.

### Rod-Like Liquid Crystal Compound

As the rod-like liquid crystal compound, azomethines, azoxy, cyanobiphenyls, cyanophenyl esters, benzoic acid esters, cyclohexane carboxylic acid phenyl esters, cyanophenylcyclohexanes, cyano-substituted phenylpyrimidines, alkoxy-substituted phenylpyrimidines, phenyldioxanes, tolans, and alkenylcyclohexylbenzonitriles are preferably used.

As the rod-like liquid crystal compound, not only low-molecular liquid crystalline molecules as described above but also high-molecular liquid crystalline molecules can be used.

In the phase correction layer 16, the alignment is more preferably fixed by polymerization of the rod-like liquid crystal compound.

As the polymerizable rod-like liquid crystal compound, compounds described in Makromol. Chem., volume 190, p. 2255 (1989), Advanced Materials Vol. 5, p. 107 (1993), Advanced Photonics Vol. 2, clause 036002 (2020), US4683327A, US5622648A, UA5770107A, WO95/22586, WO95/24455, WO97/00600, WO98/23580, WO98/52905, JP1989-272551A (JPH01-272551A), JP1994-16616A (JPH06-16616A), JP1995-110469A (JPH07-110469A), JP1999-80081A (JPH11-80081A), and JP2001-64627A can be used.

Further, as the rod-like liquid crystal compound, for example, those described in JP1999-513019A (JPH11-513019A) and JP2007-279688A can also be preferably used.

### Disk-Like Liquid Crystal Compound

As the disk-like liquid crystal compound, for example, compounds described in JP2007-108732A and JP2010-244038A can be preferably used.

The phase correction layer 16 in which the liquid crystal compound is aligned as described above, that is, the liquid crystal alignment pattern layer can be formed by applying a composition including a liquid crystal compound onto an alignment film having a desired alignment pattern, drying the composition, and polymerizing the liquid crystal compound as necessary, in the same manner as a well-known liquid crystal alignment pattern layer in which a liquid crystal compound is aligned.

In the optical member 10 according to the embodiment of the present invention, the phase correction layer 16 may include a support on which an alignment film is formed, the alignment film, and a liquid crystal alignment pattern layer, may include the alignment film and the liquid crystal alignment pattern layer by peeling off the support, or may include only the liquid crystal alignment pattern layer as the phase correction layer 16 attached to the substrate 12 by peeling off the alignment film from the liquid crystal alignment pattern layer.

### Alignment Film

In the optical member 10 according to the embodiment of the present invention, various well-known alignment films can be used as the alignment film for forming the liquid crystal alignment pattern layer forming the phase correction layer 16.

Examples of the alignment film include a rubbed film made of an organic compound such as a polymer, an oblique deposited film made of an inorganic compound, a film having a microgroove, and a film formed by accumulating Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing the surface of the polymer layer several times in a certain direction with paper or cloth.

Preferred examples of the material used for the alignment film include polyimide, polyvinyl alcohol, a polymer having a polymerizable group described in JP1997-152509A (JP-H9-152509A), JP2005-97377A, JP2005-99228A, and a material used for forming an alignment film described in JP2005-128503A.

In the optical member according to the embodiment of the present invention, for example, the alignment film can be suitably used as a so-called photo-alignment film obtained by irradiating a photo-alignment material with polarized light or non-polarized light to form an alignment film. That is, in the optical member according to the embodiment of the present invention, a photo-alignment film that is formed by applying a photo-alignment material to a support is suitably used as the alignment film.

The irradiation of polarized light can be performed from a vertical direction or an oblique direction with respect to the photo-alignment film, and the irradiation of non-polarized light can be performed from an oblique direction with respect to the photo-alignment film.

Preferred examples of the photo-alignment material used for the photo-alignment film usable in the embodiment of the present invention include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, an aromatic ester compound described in JP2002-229039A, maleimide and/or alkenyl-substituted nadimide compounds having a photo-alignment unit described in JP2002-265541A and JP2002-317013A, photo-crosslinkable silane derivatives described in JP4205195B and JP4205198B, photo-crosslinkable polyimides, photo-crosslinkable polyamides, and photo-crosslinkable esters described in JP2003-520878A, JP2004-529220A, and JP4162850B, and photo-dimerizable compounds described in JP1997-118717A (JPH09-118717A), JP1998-506420A (JPH10-506420A), JP2003-505561A, WO2010/150748A, JP2013-177561A, and JP2014-12823A, in particular, cinnamate compounds, chalcone compounds, and coumarin compounds.

Among these, an azo compound, a photo-crosslinkable polyimide, a photo-crosslinkable polyamide, a photo-crosslinkable ester, a cinnamate compound, or a chalcone compound is suitability used.

The thickness of the alignment film is not particularly limited and may be appropriately set according to the material for forming the alignment film such that a required alignment function can be obtained.

The thickness of the alignment film is preferably 0.01 to 5 μm and more preferably 0.05 to 2 μm.

The method of forming the alignment film is not limited, and various known methods can be used according to the material for forming the alignment film.

As an example, in a case of an alignment film using a photo-alignment material, a method in which a composition including an alignment film is applied to a surface of a support and dried, and then the alignment film is exposed to laser light to form an alignment pattern is exemplified.

In addition, in a case where an alignment film corresponding to a diffraction grating is formed using a photo-alignment material, it is also possible to use a method of forming an alignment film by using a mask having a slit-shaped opening and irradiating the photo-alignment material with linearly polarized light through the mask and a polarizer such as a wire grid polarizer. Specifically, after the photo-alignment material is irradiated with linearly polarized light through the slit and the polarizer, the slit is moved in the width direction by a predetermined amount, the direction (angle) of the transmission axis of the polarizer is adjusted, and the photo-alignment agent material is repeatedly irradiated with linearly polarized light again through the slit and the polarizer. As a result, a photo-alignment film corresponding to the diffraction grating having a stripe-shaped alignment pattern can be formed.

The optical member 10 according to the embodiment of the present invention described above has the phase correction layer 16 using a liquid crystal compound.

However, the optical member according to the embodiment of the present invention is not limited to this configuration, and the phase correction layer may be formed of a member having a height that changes corresponding to the phase modulation amount.

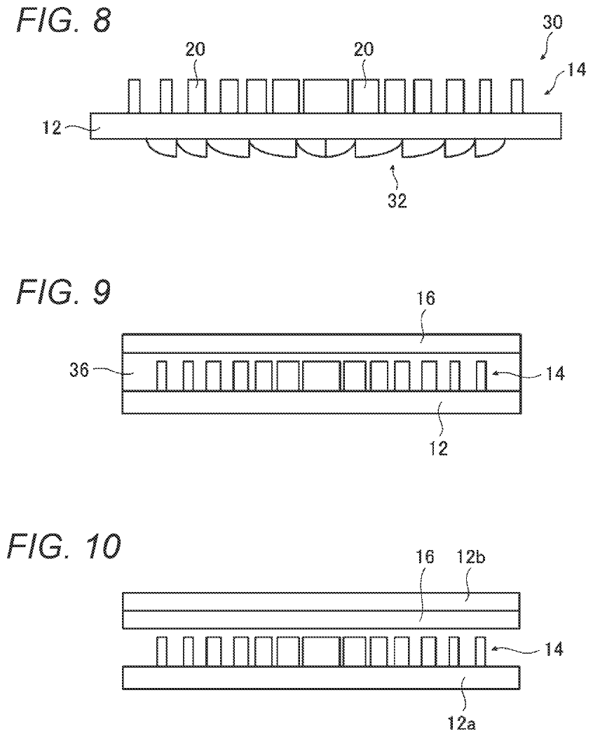

FIG. 8 illustrates an example of this configuration.

Since an optical member 30 illustrated in FIG. 8 has the same substrate 12 and metasurface structure 14 as those of the optical member 10 described above, the same members are denoted by the same reference numerals, and the following description will be made mainly on different points.

In the following description, for convenience, the above-described optical member 10 will also be referred to as a first aspect of the present invention, and the optical member 30 illustrated in FIG. 8 will also be referred to as a second aspect of the present invention.

The optical member 30 illustrated in FIG. 8 has the metasurface structure 14 on one surface of the substrate 12, and has a dielectric pattern layer having an uneven pattern formed by a dielectric on the other surface as a phase correction layer 32.

In the phase correction layer 32, one protrusion corresponds to one region in the phase correction layer.

In such a phase correction layer 32, that is, the dielectric pattern layer, as the height of the dielectric increases, the phase modulation amount increases, that is, the refractive index increases.

Accordingly, in the same manner as in the phase correction layer 16 described above, in the phase correction layer 32, protrusions having heights that continuously decrease in the same direction are arrayed corresponding to the region X of the metasurface structure 14 such that the refractive index gradually decreases toward the array of the region X in the region A of the metasurface structure 14, that is, the decrease direction of the phase modulation amount in the region A.

With this configuration, as in the optical member 10 of the first aspect illustrated in FIG. 6, the phase modulation characteristic of the optical member 10 becomes a continuous phase modulation distribution by a combination of the discrete phase modulation distribution of the metasurface structure 14 and the phase modulation distribution corresponding to the region X of the metasurface structure 14 with the phase correction layer 32.

As a result, the wavefront aberration of the metasurface structure 14 can be corrected, and the wavefront of light to be condensed can be set to an appropriate curved surface shape.

That is, basically, the phase correction layer 32 in the optical member 30 according to the second aspect of the present invention may have the same phase modulation distribution as the phase correction layer 16 in the optical member 10 according to the first aspect of the present invention for the same metasurface structure 14.

Thus, the optical member 10 according to the first aspect of the present invention illustrated in FIG. 6 becomes the optical member 30 according to the second aspect of the present invention by changing the phase correction layer 16 to the phase correction layer 32.

In the optical member 30 according to the second aspect of the present invention, the dielectric pattern layer to be the phase correction layer 32 has unevenness.

However, the phase correction layer 32 is not thicker than “λ/[2×(n−1.0)] ” and not thicker than half of the diffraction lens (Fresnel lens). Thus, the phase correction layer 32 does not need to be processed into a steep groove shape in the plane. In this expression, λ is a wavelength of target light, and n is a refractive index of a material for forming the phase correction layer.

In the optical member 30 according to the second aspect of the present invention, a material for forming the dielectric pattern layer that becomes the phase correction layer 32 is not limited, and various known dielectrics can be used.

Examples thereof include resins such as a polyacrylic resin, for example, polymethyl methacrylate, a cellulosic resin, for example, cellulose triacetate, a cycloolefin polymer resin, a polyethylene terephthalate (PET) resin, a polycarbonate resin, and a polyvinyl chloride resin, and glass.

A method of forming the phase correction layer 32, that is, a method of forming the dielectric pattern layer, is not limited, and the layer may be formed by a well-known method depending on a forming material. Examples thereof include methods such as formation using a micro 3D printer, press molding, extrusion molding, injection molding, vacuum molding, blow molding, and a cutting method.

In the optical member according to the embodiment of the present invention, the method of designing the phase correction layers (the phase correction layer 16 and the phase correction layer 32) is not limited, and various methods can be used.

As an example, in the case of the condenser lens as in the illustrated example, the phase correction layer may be designed using a computer simulation such that the plane wave transmitted through the metasurface structure 14, the substrate 12, and the phase correction layer has an ideal phase modulation amount for the purpose of condensation by the lens.

As described above, the phase modulation amount (phase modulation distribution) in the phase correction layer can be adjusted by the alignment and array of the liquid crystal compound in the phase correction layer 16 using the liquid crystal compound, and can be adjusted by the height and array of the unevenness of the dielectric pattern layer in the phase correction layer 32 having the dielectric pattern layer.

Any of the above-described optical members has the metasurface structure 14 on one surface of the substrate 12 and has the phase correction layer on the other surface, but the present invention is not limited to this configuration, and various configurations can be used.

As an example, as conceptually illustrated in FIG. 9 exemplified in the optical member using the phase correction layer 16 using a liquid crystal compound, a configuration in which the metasurface structure 14 is provided on one surface of the substrate 12, the metasurface structure 14 is embedded in a filling layer 36, and the phase correction layer 16 is provided on the surface of the filling layer 36 is exemplified.

The filling layer 36 is not limited as long as it transmits light having a wavelength targeted by the metasurface structure 14, and examples thereof include layers formed of various resin materials.

Alternatively, as conceptually illustrated in FIG. 10, the optical member according to the embodiment of the present invention may have a configuration in which the metasurface structure 14 is provided on one surface of a first substrate 12a, the phase correction layer 16 is provided on one surface of a second substrate 12b, and the metasurface structure 14 and the phase correction layer 16 are disposed to face each other.

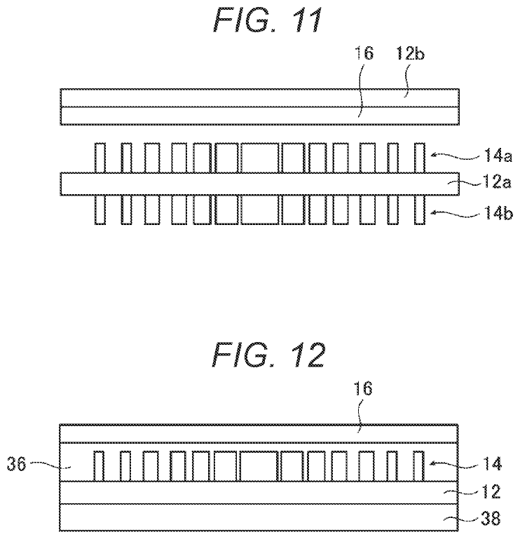

As conceptually illustrated in FIG. 11, the optical member according to the embodiment of the present invention may have a configuration in which a first metasurface structure 14a is provided on one surface of the first substrate 12a, a second metasurface structure 14b is provided on the other surface of the first substrate 12a, the phase correction layer 16 is provided on one surface of the second substrate 12b, and one metasurface structure and the phase correction layer 16 are disposed to face each other.

Further, the optical member according to the embodiment of the present invention may be a reflective optical member instead of a transmissive optical member.

For example, as conceptually illustrated in FIG. 12, in the optical member illustrated in FIG. 9, a reflective layer 38 may be provided on the surface of the substrate 12 opposite to the formation surface of the metasurface structure 14 to form a reflective optical member such as a reflective lens or a reflective diffraction grating.

In the reflective optical element illustrated in FIG. 12, light is incident from the phase correction layer 16 side, is transmitted through the phase correction layer 16, the metasurface structure 14, and the substrate 12, and is reflected by the reflective layer 38. The light reflected by the reflective layer 38 is transmitted through the substrate 12, the metasurface structure 14, and the phase correction layer 16, and is emitted as diffracted reflected light.

In the example illustrated in FIG. 12, the metasurface structure 14 is embedded in the filling layer 36, and the phase correction layer 16 is provided thereon, but the present invention is not limited to this configuration. For example, as in Example 3 to be described later, the phase correction layer 16 may be provided on a surface of a sheet-like support made of the same material as the substrate 12, and this stack may be directly stacked on the metasurface structure 14.

In addition, as described above, in a case where the phase correction layer 16 is formed using a liquid crystal compound, a liquid crystal alignment pattern layer that exhibits a function as the phase correction layer 16 is formed on the alignment film.

Thus, in this case, as described above, the phase correction layer 16 including the support, the alignment film, and the liquid crystal alignment pattern layer may be directly stacked on the metasurface structure 14. Alternatively, the support may be peeled off from the stack having the support, the alignment film, and the liquid crystal alignment pattern layer, and the phase correction layer 16 having the alignment film and the liquid crystal alignment pattern layer may be directly stacked on the metasurface structure 14. Alternatively, the alignment film may be peeled off from the stack having the support, the alignment film, and the liquid crystal alignment pattern layer, and the phase correction layer 16 formed of only the liquid crystal alignment pattern layer may be directly stacked on the metasurface structure 14.

The reflective layer 38 is not limited, and various well-known reflective layers (reflective members) such as a metal mirror, a metal film such as a copper film, and a dielectric multilayer reflective film can be used as long as they can reflect light having a target wavelength.

The thickness of the reflective layer 38 is not limited either, and the thickness at which the required reflectivity is obtained may be appropriately set according to the material for forming the reflective layer 38.

The optical member according to the embodiment of the present invention has been described in detail, but the present invention is not limited to the above-described example and various improvements and changes can be made without departing from the scope of the present invention.

### EXAMPLES

Features of the present invention will be more specifically described below by way of Examples.

The following Examples illustrates one example of the present invention.

Thus, the scope of the invention is not limitedly interpreted by the following specific examples of the present invention.

### Production of Metasurface Structure 1

A metasurface structure 1 to be a condenser lens described below was produced by optical simulation.

A 250 mm thick silicon substrate including a 50 μm thick insulating layer (SiO₂) was prepared.

On a surface of this silicon substrate, cylindrical resonators made of silicon and having a height of 500 μm and a diameter of L um were arrayed to produce a metasurface structure. In the metasurface structure, as conceptually illustrated in FIG. 13, one unit cell (region X) had a square shape of 400×400 μm, and a resonator was disposed at the center of the unit cell. In FIG. 13, the height of the resonator is illustrated to be low in order to simplify the drawing.

Eight types of resonators having a diameter L of 50 to 305 μm listed in the following table were used.

The amplitudes and phase modulation amounts [°] of the waves to transmit through the silicon cylindrical resonator were calculated by the finite element method simulation software “COMSOL Multiphysics” available from COMSOL.

TABLE 1

| No. | 1 | 2 | 3 | 4 | 5 | 6 | 7 | 8 |
|---|---|---|---|---|---|---|---|---|
| Amplitudes | 0.95 | 0.98 | 0.99 | 0.98 | 0.96 | 0.97 | 0.99 | 0.98 |
| Phase [°] | 5 | 44.6 | 85.2 | 130.9 | 186.5 | 226.4 | 270 | 323.5 |
| L [μm] | 50 | 170 | 200 | 220 | 240 | 255 | 275 | 305 |

In this table, [Phase] means phase modulation amounts through resonator

Using the resonators of Nos. 1 to 8 listed in the above table, unit cells were formed and arrayed by disposing the resonators such that the distribution of the phase modulation amount was as illustrate in FIG. 14, and condenser lenses having 12 mm focal lengths were produced. On the right side of FIG. 14, an array state of the resonators in the condenser lens is shown by illustrated six resonators.

The set frequency was 300 GHz (wavelength of 1000 μm).

Such a metasurface structure can be produced by a typical silicon semiconductor manufacturing process.

In the case of the present Example, as an example, a silicon-on-insulator (SOI) wafer including a device layer (Si) having a thickness of 500 μm, an insulating layer (SiO₂) having a thickness of 50 μm, and a substrate having a thickness of 250 μm may be used, and a cylindrical shape may be formed on the device layer by dry etching with an inductively coupled plasma (ICP) etching device using a photoresist as a mask to produce a metasurface structure.

### Example 1A

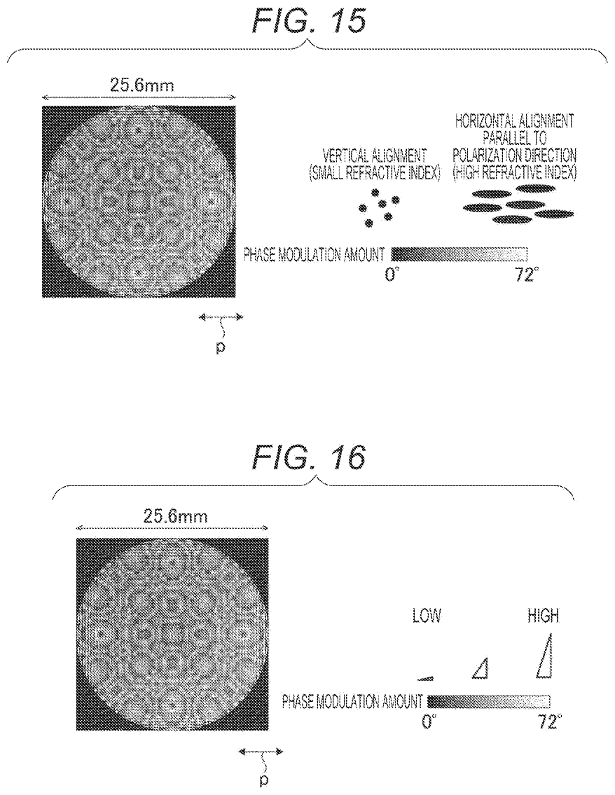

A phase correction layer (liquid crystal alignment pattern layer) using a liquid crystal compound, the liquid crystal having a plurality of regions having different alignment directions, a thickness of 1300 μm, and a phase modulation distribution illustrated in FIG. 15, was formed by simulation on the surface opposite to the metasurface structure of the silicon substrate on which the metasurface structure 1 was formed, whereby an optical member to be a condenser lens was produced.

With respect to the polarization direction p illustrated in FIG. 15, the liquid crystal compound arrayed in a horizontal alignment has a relatively large phase modulation amount, that is, a refractive index, and the liquid crystal compound arrayed in a vertical direction has a relatively small phase modulation amount, that is, a refractive index. Thus, as described above, a desired phase modulation amount can be obtained by controlling the allay direction of the liquid crystals.

The phase modulation amount of the phase correction layer (liquid crystal layer) was designed using computer simulation such that the plane wave transmitted through the metasurface structure, the substrate, and the phase correction layer had an ideal phase modulation amount for the purpose of condensation by the lens.

### Example 1B

A dielectric pattern layer having the phase modulation distribution illustrated in FIG. 16 was formed by simulation using PMMA as a phase correction layer on the surface opposite to the metasurface structure of the silicon substrate on which the metasurface structure 1 was formed, whereby an optical member to be a condenser lens was produced.

Since the refractive index of the PMMA layer is larger than that of air, a portion having a high structure has a large phase modulation amount, that is, a large refractive index, and a portion having a low structure has a small phase modulation amount, that is, a small refractive index. Thus, as described above, a desired phase modulation amount can be obtained by controlling the height of the dielectric pattern layer.

The phase modulation amount of the phase correction layer (dielectric pattern layer) was designed using a computer simulation such that the plane wave transmitted through the metasurface structure, the substrate, and the phase correction layer had an ideal phase modulation amount for the purpose of condensation by the lens.

### Comparative Example 1

An optical member serving as a condenser lens having only a substrate and the metasurface structure 1 without a phase correction layer was used as Comparative Example 1.

### Evaluation 1

The light condensing efficiency of the optical members (condensing lenses) of Example 1A, Example 1B, and Comparative Example 1 was examined using numerical simulation by a fast Fourier transformation beam propagation method (FFT-BPM).

The light condensing efficiency was defined as a proportion of light beams transmitted through the inside of an aperture having a radius of three times the half-width of the condensed spot on a focal plane distant from the optical member by 12 mm, among light beams transmitted through a circular optical member having a radius of 25.6 mm.

As a result,
the light condensing efficiency of the 1A of Example was 0.81,
the light condensing efficiency of the 1B of Example was 0.84, and
the light condensing efficiency of Comparative Example 1 was 0.74.

From the above results, it was shown that the condenser lens formed of the optical member according to the embodiment of the present invention has high light condensing efficiency, that is, high use efficiency of light.

The condenser lens also acts as a collimator lens by allowing diffused light emitted from one point to be incident thereon. That is, the optical member of the present invention has high use efficiency of light even as a collimator lens.

As an example, the liquid crystal alignment pattern layer to be a phase correction layer can be produced by forming an alignment film having a target alignment pattern and forming a liquid crystal layer thereon as follows.

### Formation of Photo-Alignment Film>

To 1 part by mass of a photo-alignment material E-1 having the following structure, 41.6 parts by mass of butoxyethanol, 41.6 parts by mass of dipropylene glycol monomethyl, and 15.8 parts by mass of pure water are added, and the obtained solution is pressure-filtered through a 0.45 μm membrane filter to prepare a coating liquid for a photo-alignment film.

Next, the obtained coating liquid for a photo-alignment film is applied to a support and dried for 1 minute at 60° C. Thereafter, the obtained coating film is irradiated with linearly polarized ultraviolet rays (illuminance: 4.5 mW/cm², cumulative irradiation amount: 300 mJ/cm2) using a polarized ultraviolet exposure device to produce a photo-alignment film P-1 having an alignment regulating force in a horizontal direction. Next, the obtained photo-alignment film P-1 is irradiated with non-polarized ultraviolet rays (illuminance 4.5 mW/cm², cumulative irradiation amount: 2000 mJ/cm²) from a direction perpendicular to the film surface through a gray scale photo mask to produce a pattern-exposed photo-alignment film.

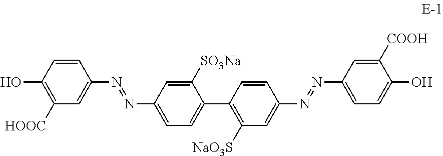

### <Liquid Crystal Composition>

As the liquid crystal composition forming the liquid crystal layer (phase correction layer), the following composition A-1 is prepared.

### Composition A-1

| | | |
|---|---|---|
| Liquid crystal compound L-1: | 100.00 | parts by mass |
| Polymerization initiator (manufactured by BASF SE, Irgacure OXE01): | 1.00 | parts by mass |
| Leveling agent T-1: | 0.08 | parts by mass |
| Methyl ethyl ketone: | 1050.00 | parts by mass |

Liquid crystal compound L-1 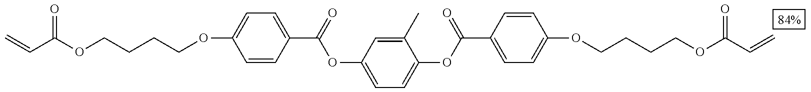 [SMILES: C=CC(=O)OCCCCOc1ccc(C(=O)Oc2ccc(OC(=O)c3ccc(OCCCCOC(=O)C=C)cc3)c(C)c2)cc1] 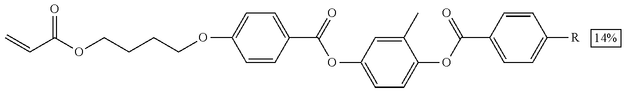 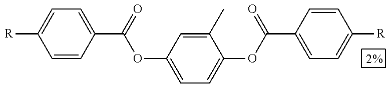 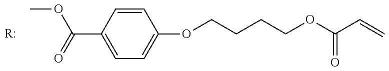
Leveling agent T-1

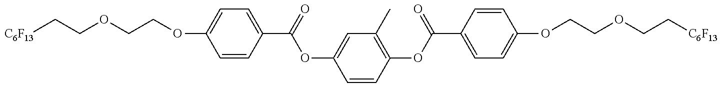

### <Liquid Crystal Alignment Pattern Layer>

First, the following composition A-1 was applied onto the photo-alignment film P-1 as the first layer, the coating film was heated on a hot plate at 80° C., and then the coating film was irradiated with ultraviolet rays having a wavelength of 365 nm at an irradiation amount of 300 mJ/cm² using a high-pressure mercury-vapor lamp in a nitrogen atmosphere, thereby fixing the alignment of the liquid crystal compound.

For the second and subsequent layers, this liquid crystal fixing layer was overcoated, and ultraviolet curing was performed after heating under the same conditions as described above to produce a liquid crystal fixing layer. In this manner, the overcoating was repeated until the total thickness reached a desired film thickness to form a liquid crystal alignment pattern layer, whereby a liquid crystal layer to be a phase correction layer was produced. In the liquid crystal layer, there are a region in which the horizontally aligned liquid crystal compound is fixed, a region in which the vertically aligned liquid crystal compound is fixed, and in between the regions, a region in which the alignment direction of the liquid crystal compound gradually changes from the horizontal alignment toward the vertical alignment and is fixed.

The liquid crystal alignment pattern layer formed of the composition A-1 has a refractive index of 1.7 at the time of horizontal alignment and a refractive index of 1.55 at the time of vertical alignment, and can provide a phase difference because of a difference in refractive index between the time of horizontal alignment and the time of vertical alignment.

As an example, the dielectric pattern layer to be a phase correction layer may be produced using a micro 3D printer by producing an uneven pattern of the dielectric pattern layer as described above.

### Production of Metasurface Structure 2

A metasurface structure 2 described below was produced by an optical simulation.

For the metasurface structure 2, a silicon oxide substrate having a thickness of 300 μm was used as a substrate. One unit cell (region X) had a configuration in which the resonators of Nos. 1 to 8 described above were used, and each resonator was disposed at the center of a square having a 400×400 of μm as illustrated in FIG. 13, as in the metasurface structure 1.

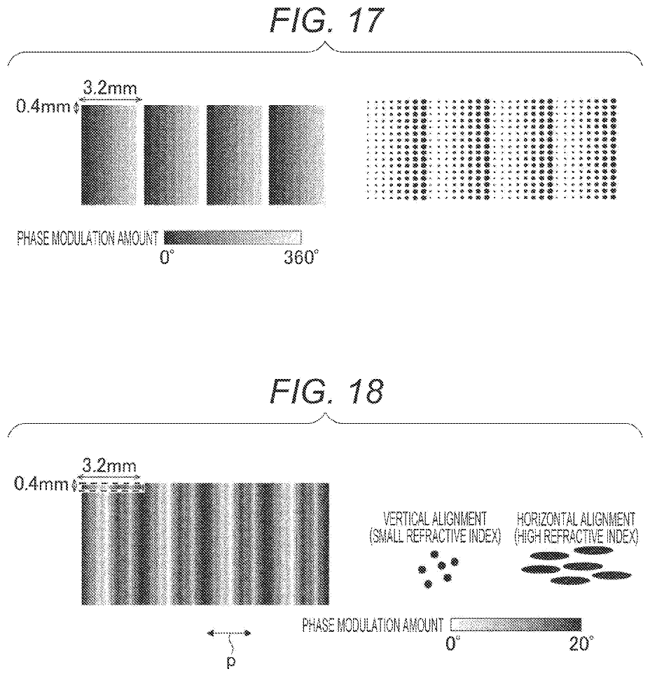

Unit cells were formed by disposing the resonators so as to have the distribution of the phase modulation amount illustrated on the left side of FIG. 17, and the metasurface structure 2 serving as a transmissive diffraction grating was produced. The design frequency was set to 300 GHz (1000 μm).

As illustrated in FIG. 17, the metasurface structure 2 has a repeating structure of blocks of 0.4×3.2 mm having an array of unit cells in which resonators Nos. 1 to 8 are sequentially used.

### Example 2

A phase correction layer (liquid crystal alignment pattern layer) having a plurality of regions having different alignment directions, the layer having a thickness of 400 μm and having a phase modulation distribution illustrated in FIG. 18, the layer being formed of a liquid crystal compound, was formed by simulation on a surface of the silicon substrate on which the metasurface structure 2 was formed, the surface being opposite to the metasurface structure, whereby an optical member to be a transmissive diffraction grating was produced.

With respect to the polarization direction p illustrated in FIG. 18, the liquid crystal compound arrayed in the horizontal alignment has a relatively large phase modulation amount, that is, a refractive index, and the liquid crystal compound arrayed in the vertical alignment has a relatively small phase modulation amount, that is, a refractive index. Thus, as described above, a desired phase modulation amount can be obtained by controlling the array direction of the liquid crystals.

The phase modulation amount of the phase correction layer (liquid crystal layer) was designed using computer simulation such that the plane wave transmitted through the metasurface structure, the substrate, and the phase correction layer had an ideal phase modulation amount necessary for the diffraction grating.

### Comparative Example 2

An optical member serving as a transmissive diffraction grating having only a substrate and the metasurface structure 2 without a phase correction layer was set as Comparative Example 1.

### Evaluation 2

Regarding the diffraction efficiency of the optical members (diffraction gratings) of Example 2 and Comparative Example 2, the diffraction efficiency was examined using a numerical simulation by a fast Fourier transformation beam propagation method (FFT-BPM).

The diffraction efficiency was defined as the proportion of rays diffracted in the +1 order diffraction direction in the incident plane wave.

As a result,
the diffraction efficiency of Example 2 was 0.95, and
the diffraction efficiency of Comparative Example 2 was 0.88.

From the above results, it was shown that the diffraction efficiency of the diffraction grating formed of the optical member according to the embodiment of the present invention was high, that is, the light use efficiency was high.

### Production of Reflective Metasurface Diffraction Grating 1 (Example)

A reflective metasurface diffraction grating 1 described below was produced.

A COP film was produced by the method described in JP4991170B. The thickness of the COP film was 40 μm.

Next, the produced COP film was cut into a square shape of 4×4 cm. The surface of the cut COP film was subjected to ultrasonic cleaning (45 kHz) and then placed at a film forming position inside a sputtering film forming apparatus. After the pressure inside the apparatus was reduced, argon gas was introduced, and sputtering was performed using Cu as a target to form a copper layer having a thickness of 200 μm on a surface of the COP film.

By sequentially forming this copper layer on each surface of the COP film, a copper layer having a thickness of 200 nm was formed on both surfaces.

Next, the photosensitive transfer member (negative transfer material 1) described in JP2020-204757A was drawn out, and one cover film was peeled off from the photosensitive transfer member.

Next, the photosensitive transfer member and one surface (copper layer) of the formed COP film having copper layers formed on both surfaces thereof were bonded to each other such that the photosensitive resin layer exposed by the peeling of the cover film and the copper layer were in contact with each other, whereby a stack was obtained. This bonding step was performed under the conditions of a roll temperature of 100° C., a linear pressure of 1.0 MPa, and a linear speed of 4.0 m/min.

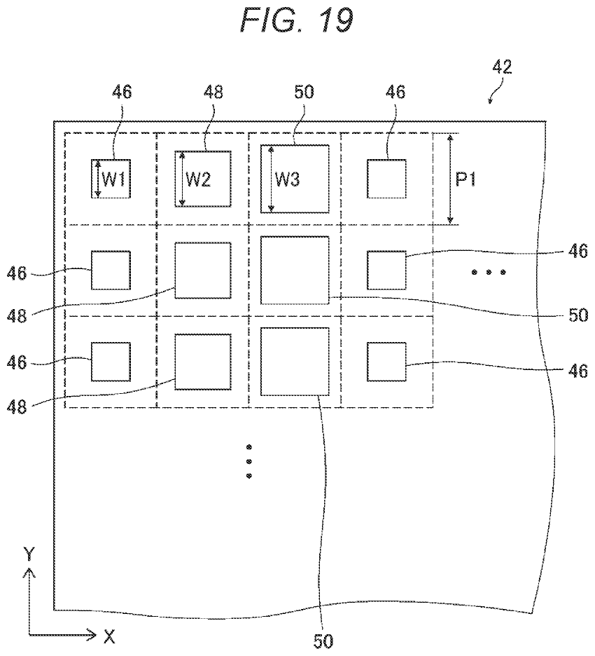

The obtained stack was subjected to 100 mJ/cm² irradiation with an ultra-high-pressure mercury-vapor lamp (exposure dominant wavelength: 365 nm) from the cover film side of the photosensitive transfer member through a photomask 42 illustrated in FIG. 19 to expose the photosensitive resin layer.

In the photomask 42 illustrated in FIG. 19, square sections each having a side of P1 (1041 μm) are two dimensionally set in a square lattice shape in an X direction and a Y direction orthogonal to each other. The X direction and the Y direction correspond to an X direction and a Y direction of a reflective metasurface diffraction grating (metasurface structure) described later.

At the center of each square section, any one of a square opening 46 with a side having a length of W1 (400 μm), a square opening 48 with a side having a length of W2 (820 μm), or a square opening 50 with a side having a length of W3 (935 μm) is formed.

In the photomask 42, as illustrated in FIG. 19, the opening 46, the opening 48, and the opening 50 are repeatedly formed in this order in the X direction. The same openings are arrayed in the Y direction. That is, the photomask 42 has repetitive rows of the opening 46, the opening 48, the opening 50, the opening 46, the opening 48, the opening 50, the opening 46, and the opening 48 . . . in the X direction, and the rows toward the X direction are arrayed in the Y direction.

After the exposure of the photosensitive transfer member, the photomask 42 was removed, and the cover film was peeled off from the photosensitive transfer member.

Thereafter, shower development was performed for 30 seconds using a 1.0% by mass sodium carbonate aqueous solution at a liquid temperature of 25° C. to form a resist pattern formed of a photosensitive transfer member on the copper layer.

The stack having the resist pattern formed thereon was subjected to copper etching at 23° C. for 30 seconds using a copper etching solution (Cu-02, manufactured by Kanto Chemical Co., Inc).

Thereafter, the resist pattern was peeled off using propylene glycol monomethyl ether acetate to form a metasurface structure, whereby a reflective metasurface diffraction grating 1 was produced.

That is, the reflective metasurface diffraction grating 1 has a metasurface structure in which a square section having a side with a length P1 (1041 μm) is set in a square lattice shape in the X direction and the Y direction on one surface of a 40 μm-thick base material made of COP, a square plate-shaped resonator having a thickness of 200 nm and a side with a length of W1 (400 μm) in the X direction, a square plate-shaped resonator having a thickness of 200 nm and a side with a length W2 (820 μm) in the X direction, and a square plate-shaped resonator having a thickness of 200 nm and a side with a length of W3 (935 μm) in the X direction, are repeatedly arrayed in this order at the center of square section, and the same resonators are arrayed in the Y direction, anda copper layer that serves as a reflective layer is provided on one surface of the base material made of COP.

Thus, in this metasurface structure, a square section having one resonator and a side with a length P1 of 1041 μm serves as a unit cell.

In the following description, the “square plate-shaped resonator” will also be referred to as a “square resonator”.

### Production of Reflective Metasurface Diffraction Grating 2 (Comparative Example)

A reflective metasurface diffraction grating 2 was produced in the same manner as in the production of the reflective metasurface diffraction grating 1 except that the photomask used for the exposure of the photosensitive transfer member in the production of the reflective metasurface diffraction grating 1 was changed to a photomask in which the opening 46 had a side with a length W1 of 590 μm, the opening 48 had a side with a length W2 of 900 μm, and the opening 50 had a side with a length W3 of 925 μm.

That is, the reflective metasurface diffraction grating 2 has a metasurface structure in which a square-shaped resonator having a thickness of 200 nm and a side with a length W1 of 590 μm, a square-shaped resonator having a thickness of 200 nm and a side with a length W2 of 900 μm, and a square resonator having a thickness of 200 nm and a side with a length W3 of 925 μm are repeatedly arrayed in this order at the centers of square sections with a side having a length P1 of 1041 μm that are two dimensionally set in a square lattice shape, and the same resonators are arrayed in the Y direction.

The metasurface structures of the produced reflective metasurface diffraction grating 1 and reflective metasurface diffraction grating 2 were designed such that light of 100 GHZ frequencies incident from the normal direction was diffracted and reflected in a direction of a polar angle of 73.7°.

That is, both the reflective metasurface diffraction grating 1 and the reflective metasurface diffraction grating 2 are reflective diffraction gratings having a +1 order direction of 73.7°, a 0 order direction of 0° (regular reflection), and a −1 order direction of −73.7°.

In the reflective metasurface diffraction gratings, since the reflection efficiency of the resonators is different between Examples having the phase correction layer and Comparative Examples having no phase correction layer, the size of the resonators is adjusted in order to match the reflection angle.

### Example 3

### <Formation of Photo-Alignment Film>

The photo-alignment film P-1 having an alignment regulating force in the horizontal direction was produced by the method described above. The thickness of the photo-alignment film P-1 was 60 nm.

As a support for forming the photo-alignment film P-1, a float glass having a size of 4×4 cm and a thickness of 1 mm was used.

A stripe-shaped mask in which a transmission portion having a width of 347 μm and a light-shielding portion having a width of 2776 μm were alternately formed was prepared. In this mask, the array direction of the stripes corresponds to the X direction of the reflective metasurface diffraction grating (metasurface structure), and the array direction of the stripes corresponds to the Y direction. The photo-alignment film P-1 was covered with the mask such that the end portion of the transmission portion in the width direction coincided with one end side of the photo-alignment film P-1 and the transmission portion was positioned in the plane of the photo-alignment film P-1.

Next, the photo-alignment film P-1 was irradiated with ultraviolet rays linearly polarized by a wire grid polarizer (manufactured by Moxtek, ProFlux PPL02) installed in such a manner that the angle of the absorbtion axes became ϕ1 (=0°), using an ultraviolet exposure device. Regarding the ultraviolet rays, the illuminance was set as 4.5 mW/cm², and the cumulative irradiation amount was set as 300 mJ/cm².

The angle of the absorption axis is an angle with respect to the width direction of the stripe, and the clockwise direction is positive. That is, the angle of the absorption axis being 0° is a state where the angle of the absorption axis coincides with the width direction (X direction) of the stripe. That is, the angle of the absorption axis being 90° is a state where the angle of the absorption axis coincides with the longitudinal direction (Y direction) of the stripe.

Next, the mask was moved by 347 μm in the width direction of the stripe, the wire grid polarizer was rotated such that the angle of the absorption axis was ϕ2 (=16°), and the photo-alignment film P-1 was irradiated with linearly polarized ultraviolet rays in the same manner.

Next, the mask was moved by 347 μm in the width direction of the stripe, the wire grid polarizer was rotated such that the angle of the absorption axis was ϕ3 (=86°), and the photo-alignment film P-1 was irradiated with linearly polarized ultraviolet rays in the same manner.

The movement of the mask and the ultraviolet irradiation of the photo-alignment film P-1 were performed until the angle of the absorption axes of the wire grid polarizer was polarized to ϕ4, ϕ5, . . . , ϕ9.

A photo-alignment film having a stripe-shaped alignment pattern with a width of 347 μm in which the angles ϕ1 to ϕ9 in the alignment direction were repeated was thus produced.

The angles of the absorption axes of the wire grid polarizers were set as follows:
ϕ1 was 0°, ϕ2 was 16°, ϕ3 was 86°,
ϕ4 was 86°, ϕ5 was 0°, ϕ6 was 6°,
ϕ7 was 68°, ϕ8 was 29°, and ϕ9 was 4°.

### <Production of Phase Correction Layer>

A liquid crystal alignment pattern layer having a thickness of 500 μm was formed on the photo-alignment film as described above by the above-described method using the composition A-1, and then the liquid crystal alignment pattern layer was peeled off from the photo-alignment film, whereby a phase correction layer was obtained.

The angle of the absorption axis of the wire grid polarizer in a case where the photo-alignment film is formed is as described above.

Thus, the formed phase correction layer (liquid crystal alignment pattern layer) has a liquid crystal alignment pattern in which the angle of the optical axis of the liquid crystal compound in a stripe shape having a width of 347 μm repeats ϕ1 (0°), ϕ2 (16°), ϕ3 (86°), ϕ4 (86°), ϕ5 (0°), ϕ6 (6°), ϕ7 (68°), ϕ8 (29°), and ϕ9 (4°) in the array direction of the stripes.

In addition, it was confirmed that the direction of the optical axis (slow axis) of the liquid crystal compound in the stripe had the angles described above by using AxoScan (manufactured by Axometrics, Inc).

### <Production of Optical Member>

The phase correction layer thus produced was stacked on the reflective metasurface diffraction grating 1 in such a manner that the liquid crystal alignment pattern faced the metasurface structure and the four sides coincided with each other, whereby an optical member serving as a reflective diffraction grating was produced.

The phase correction layer was stacked such that the width direction of the stripes in the liquid crystal alignment pattern coincided with the X direction in the metasurface structure, and the longitudinal direction of the stripes coincided with the Y direction in the metasurface structure.

As described above, in the metasurface structure, a square section having one resonator and having a side with a length of 1041 μm is a unit cell. In the metasurface structure, a square-shaped resonator having a side with a length W1 (400 μm), a square-shaped resonator having a side with a length W2 (820 μm), and a square resonator having a side with a length W3 (935 μm) are repeatedly arrayed in this order in the X direction. The same resonators are arrayed in the Y direction.

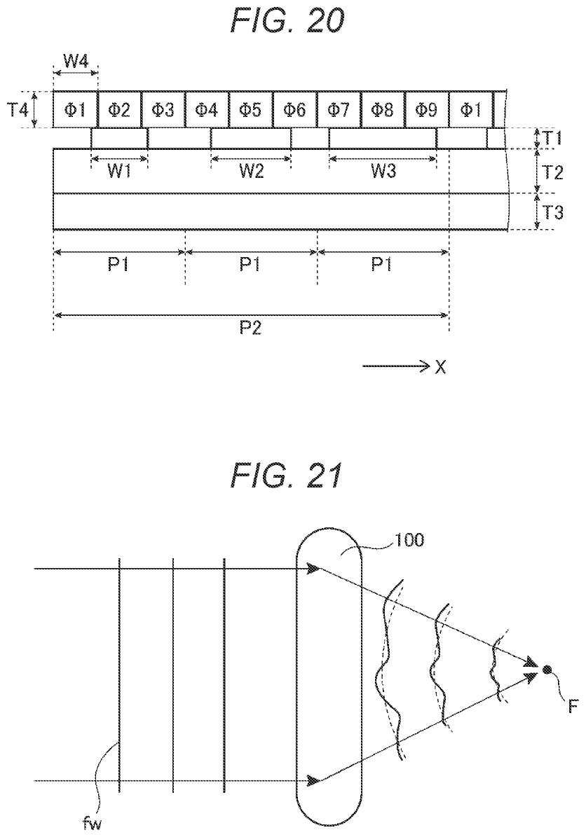

Further, the width W4 of the stripe in the liquid crystal alignment pattern was 347 μm. Thus, in this optical member, as conceptually illustrated in FIG. 20,

the regions having the angles of the optical axes of the liquid crystal compound in the phase correction layer 16 of ϕ1, ϕ2, and ϕ3 are positioned in the unit cell including the resonator having a side with a length W1, the regions having the angles of the optical axes of the liquid crystal compound in the phase correction layer 16 of ϕ4, ϕ5, and ϕ6 are positioned in the unit cell including the resonator having a side with a length W2, and the regions having the angles of the optical axes of the liquid crystal compound in the phase correction layer 16 of ϕ7, ϕ8, and ϕ9 are positioned in the unit cell including the resonator having a side with a length W3.

In FIG. 20, the Y direction is a direction orthogonal to the paper surface.

As described above, in the optical member illustrated in FIG. 20, the length W1 of one side of the square-shaped resonators constituting the metasurface structure was 400 μm, the W2 was 820 μm, the W3 was 935μm, and the thicknesses T1 was 200 nm. The length P1 of the square section serving as one unit cell is 1041 μm. Thus, a total length P2 of the three unit cells repeatedly formed is 3123 μm.

The base material is a COP film, and the thickness T2 is 40 μm.

The reflective layer is a copper layer, and the thickness T3 is 200 nm.

Further, the phase correction layer had a liquid crystal alignment pattern layer having a stripe-shaped liquid crystal alignment pattern with a thickness T4 of 500 μm, extended in the Y direction, and arrayed in the X direction, and the width W4 of the stripe was 347 μm.

### Comparative Example 3

The reflective metasurface diffraction grating 2 was used as an optical member serving as a reflective diffraction grating.

### Evaluation

The reflection efficiency of the produced optical members (reflective diffraction gratings) was measured by the following method.

Using Impatt Diode (manufactured by TeraSense) having a central wavelength of 100 GHz as a light source, diffracted reflection at a designed angle (73.7°) in a case where light was made incident on the produced optical member from the normal direction and reflected was photographed using a two dimensional Sub-THz imaging camera (Tera-1024 manufactured by TeraSense).

The integral value of the brightness of all the pixels of the imaging camera was set as the reflection intensity in the direction.

The reflection intensities in the −1 order (−73.7°) direction, the 0 order (regular reflection, 0°) direction, and the +1 order (73.7°) direction were respectively measured and defined as P−1, P0, and P1. The ratio of reflection (P1/(P−1+P0+P1) in the designed direction (+1 order, 73.7°) was defined as the reflection efficiency.

As a result,
the reflection efficiency of Example 3 was 0.61, and
the reflection efficiency of Comparative Example 3 was 0.41.

From the above results, it was shown that the reflective diffraction grating formed of the optical member according to an embodiment of the present invention has high diffraction efficiency, that is, high use efficiency of light.

The effects of the present invention are apparent from the results described above.

The optical member of the present invention can be suitably used for a wavelength selective filter, an optical sensor, and the like.

### EXPLANATION OF REFERENCES

10, 30: optical member
12: substrate
12a: first substrate
12b: second substrate
14: metasurface structure
14a: first metasurface structure
14b: second metasurface structure
16, 32: phase correction layer
20: resonator
36: filling layer
38: reflective layer
100: lens (metalens)
fw: plane wave
F: focal point

What is claimed is:

1. An optical member comprising:
a substrate;
a metasurface structure configured of a plurality of arrayed microstructures formed on at least one surface of the substrate, having a plurality of regions A each including, in case where a region including one or more of the microstructures is defined as a region X, a plurality of the regions X in which phase modulation amounts are different from each other; and
a phase correction layer that is formed on at least one surface of the substrate and corrects a wavefront aberration of the metasurface structure,
wherein in the metasurface structure, the phase modulation amounts in the regions X forming the region A gradually decrease in one direction, and the phase correction layer has a region in which the phase modulation amount changes, corresponding to the region A.

2. The optical member according to claim 1,
wherein the phase correction layer has a region in which the phase modulation amount gradually decreases, corresponding to the region A.

3. The optical member according to claim 1,
wherein the phase correction layer has a region in which the phase modulation amount changes, corresponding to two or less of the regions X.

4. The optical member according to claim 3,
wherein the phase correction layer has a region in which the phase modulation amount changes, corresponding to each of the regions X.

5. The optical member according to claim 1,
wherein the phase correction layer is a layer formed using a liquid crystal compound.

6. The optical member according to claim 5,
wherein the phase correction layer has a plurality of regions containing the liquid crystal compound having different alignment directions.

7. The optical member according to claim 6,
wherein the alignment directions of the liquid crystal compounds continuously change in the region containing the liquid crystal compound having different alignment directions.

8. The optical member according to claim 1,
wherein the phase correction layer is formed of a member of which a height changes in accordance with the phase modulation amount.

9. The optical member according to claim 8,
wherein in the member of which a height changes in accordance with the phase modulation amount, the height of the member continuously changes.

10. The optical member according to claim 1,
wherein the optical member is any of a transmissive lens, a transmissive diffraction grating, a reflective lens, or a reflective diffraction grating.

11. The optical member according to claim 1,
wherein a wavelength of light to be targeted by the metasurface structure is 10 μm to 1 cm.

12. The optical member according to claim 2,
wherein the phase correction layer has a region in which the phase modulation amount changes, corresponding to two or less of the regions X.

13. The optical member according to claim 12,
wherein the phase correction layer has a region in which the phase modulation amount changes, corresponding to each of the regions X.

14. The optical member according to claim 2,
wherein the phase correction layer is a layer formed using a liquid crystal compound.

15. The optical member according to claim 14,
wherein the phase correction layer has a plurality of regions containing the liquid crystal compound having different alignment directions.

16. The optical member according to claim 15,
wherein the alignment directions of the liquid crystal compounds continuously change in the region containing the liquid crystal compound having different alignment directions.

17. The optical member according to claim 2,
wherein the phase correction layer is formed of a member of which a height changes in accordance with the phase modulation amount.

18. The optical member according to claim 17,
wherein in the member of which a height changes in accordance with the phase modulation amount, the height of the member continuously changes.

19. The optical member according to claim 2,
wherein the optical member is any of a transmissive lens, a transmissive diffraction grating, a reflective lens, or a reflective diffraction grating.

20. The optical member according to claim 2,
wherein a wavelength of light to be targeted by the metasurface structure is 10 μm to 1 cm.
